(19) United States
(12) Patent Application Publication
(10) Pub. No.: US 2017/0066518 A1
(43) Pub. Date: Mar. 9, 2017

(54) AIRCRAFT REAR PORTION COMPRISING A VERTICAL STABILIZER HAVING A BOX-SECTION STRUCTURE INCLUDING A LOWER PORTION ACCOMMODATED IN THE FUSELAGE

(71) Applicants: Airbus Operations SAS, Toulouse (FR); Airbus Operations S.L., Getafe (ES)

(72) Inventors: Guillaume Gallant, LAREOLE (FR); Jose Luis Martinez Munoz, MADRID (ES)

(21) Appl. No.: 15/259,585

(22) Filed: Sep. 8, 2016

(30) Foreign Application Priority Data
Sep. 8, 2015 (FR) 1558311

(51) Int. Cl. B64C 1/06; B64D 29/06; B64D 41/00; B64C 5/02

(52) U.S. Cl. CPC B64C 1/068; B64C 5/02; B64D 29/06; B64D 41/00; B64C 1/069; B64D 2041/002

(57) ABSTRACT

To optimize the structure of an aircraft tail section, an aircraft rear section comprises a fuselage section, a tail section, and a vertical stabilizer comprising a box-section structure which comprises a box-section upper part extending on the outside of the tail section, and a box-section lower part housed inside the tail section, such that the tail section is wholly supported by the box-section structure.

### CROSS-REFERENCES TO RELATED APPLICATIONS

This application claims the benefit of the French patent application No. 1558311 filed on Sep. 8, 2015, the entire disclosures of which are incorporated herein by way of reference.

### BACKGROUND OF THE INVENTION

The present invention relates to the field of aircraft and is more specifically concerned with an aircraft rear section and an aircraft comprising such an aircraft rear section.

The invention relates in particular to a way of structurally arranging an aircraft tail section and to a way of connecting a vertical stabilizer to the fuselage of the aircraft.

The invention also relates to a method of assembling an aircraft rear section.

In high-wing or low-wing commercial airplanes of known types, the vertical stabilizer, also referred to as the vertical empennage, generally comprises a box-section structure which stops level with the skin of the fuselage, in the upper part of the aircraft tail section. At its lower end, the box-section structure of the vertical stabilizer is fixed to the internal structure of the tail section.

The internal structure of the tail section forms a primary structure, in the sense that this structure reacts load induced by the bending of the vertical stabilizer (in the form of shear and torsional loading), but also reacts load induced by the auxiliary power unit (also referred to as APU for short), when the latter is installed in the tail section, or even load induced by the horizontal stabilizer, whether this be directly when the horizontal stabilizer is mounted on the fuselage or indirectly when the horizontal stabilizer is mounted on the vertical stabilizer.

It is therefore desirable to optimize the structure of the tail section.

### SUMMARY OF THE INVENTION

The invention has a notable objective of affording a simple, economical and effective solution to this problem.

To this end, the invention provides an aircraft rear section, notably comprising a fuselage and a vertical stabilizer, in which the fuselage divides into a fuselage section situated on a front side of the aircraft rear section and a tail section situated on a rear side of the aircraft rear section, and in which the vertical stabilizer comprises a box-section structure.

According to the invention, the box-section structure comprises a box-section upper part extending on the outside of the tail section, and a box-section lower part housed inside the tail section, and the tail section is wholly supported by the box-section structure.

The invention thus allows the structure of the vertical stabilizer to perform a structural role within the fuselage. A structural role should be understood as meaning supporting the empennage comprising the vertical stabilizer but also supporting the tail section. The connection of the tail section to the fuselage section is thus wholly assured by the box-section structure belonging to the vertical stabilizer.

The fuselage elements that form the tail section may therefore be lightened in weight, these elements consequently no longer being required to perform a structural function.

For preference, the tail section comprises at least one external cowl pivot-mounted on the box-section structure.

For preference, the rear section further comprises an auxiliary power unit borne by the box-section structure.

In one preferred embodiment of the invention, the fuselage section comprises at least one first anchor point arranged in an upper part of the fuselage section and at least one second anchor point arranged in a lower part of the fuselage section, and the box-section lower part of the box-section structure comprises at least one third anchor point connected to the at least one first anchor point of the fuselage section, and at least one fourth anchor point connected to the at least one second anchor point of the fuselage section.

For preference, the at least one first anchor point is connected to the at least one third anchor point by means of a tension bolt able to transmit longitudinal load between the box-section structure and the fuselage section, and the at least one second anchor point is connected to the at least one fourth anchor point by means of a tension bolt able to transmit longitudinal load between the box-section structure and the fuselage section.

For preference, the rear section further comprises two lateral link rods respectively connecting two fifth anchor points, arranged on two opposite lateral portions of the fuselage section respectively, to two sixth anchor points, arranged respectively on two opposite sides of a rear portion of the box-section lower part of the box-section structure, so that the two lateral link rods contribute to laterally stabilizing the box-section structure with respect to the fuselage section.

For preference, the rear section further comprises a fuselage sealed end mounted in the fuselage section and arranged forward of the box-section structure and some distance therefrom.

For preference, the rear section further comprises a horizontal stabilizer wholly supported by the box-section structure.

The invention also relates to an aircraft comprising an aircraft rear section of the type described hereinabove.

The invention finally relates to a method of assembling an aircraft rear section, comprising the following steps:
on the one hand, a step comprising preassembling a fuselage section and, on the other hand, a step comprising preassembling an aircraft tail assembly, the aircraft tail assembly comprising a vertical stabilizer comprising a box-section structure, and a tail section attached to the box-section structure such that a box-section lower part of the box-section structure is housed inside the tail section, while a box-section upper part of the box-section structure extends on the outside of the tail section, then
a step comprising assembling the fuselage section with the aircraft tail assembly by fixing the box-section lower part of the box-section structure to the fuselage section so as to obtain an aircraft rear section of the type described above.

For preference, the fuselage section comprises at least one first anchor point arranged in an upper part of the fuselage section and at least one second anchor point arranged in a lower part of the fuselage section, and the box-section lower part of the box-section structure comprises at least one third anchor point and at least one fourth anchor point, and in which the step comprising assembling the fuselage section with the aircraft tail assembly comprises a sub-step involving connecting the at least one first anchor point to the at least one third anchor point and in connecting the at least one second anchor point to the at least one fourth anchor point.

For preference, the step comprising preassembling the aircraft tail assembly comprises a sub-step involving mounting at least one external cowl such that it can rotate on the box-section structure.

For preference, the step comprising preassembling the aircraft tail assembly comprises a sub-step involving fixing an auxiliary power unit to the box-section structure.

For preference, the step comprising preassembling the aircraft tail assembly comprises a sub-step involving fixing a horizontal stabilizer to the box-section structure.

### BRIEF DESCRIPTION OF THE DRAWINGS

The invention will be better understood, and further details, advantages and features thereof will become apparent from reading the following description given by way of nonlimiting example and with reference to the attached drawings in which:

FIG. 1 is a schematic side view of an aircraft according to a preferred embodiment of the invention;

FIG. 2 is a schematic partial perspective view of a rear section of the aircraft of FIG. 1;

FIGS. 3 and 4 are schematic partial perspective views of the rear section of the aircraft of FIG. 1;

FIGS. 5 and 6 are schematic partial views, from the rear and above respectively, of the rear section of the aircraft of FIG. 1;

FIG. 7 is a schematic partial perspective view of a fuselage section belonging to the rear section of the aircraft of FIG. 1;

FIG. 8 is a schematic partial perspective view of a tail assembly belonging to the aircraft of FIG. 1;

FIG. 9 is a schematic partial view from above of the rear section of the aircraft of FIG. 1;

FIG. 9a is a view on a larger scale of detail IXa of FIG. 9;

FIG. 10a is a schematic partial view from above of the rear section of the aircraft of FIG. 1;

FIGS. 10b and 10c are schematic partial side views of the rear section of the aircraft of FIG. 1;

FIG. 10d is a partial schematic view of the rear section of the aircraft of FIG. 1, viewed from the rear;

FIG. 11 is a partial schematic side view of the rear section of the aircraft of FIG. 1, illustrating a method for assembling same.

### DETAILED DESCRIPTION OF THE PREFERRED EMBODIMENTS

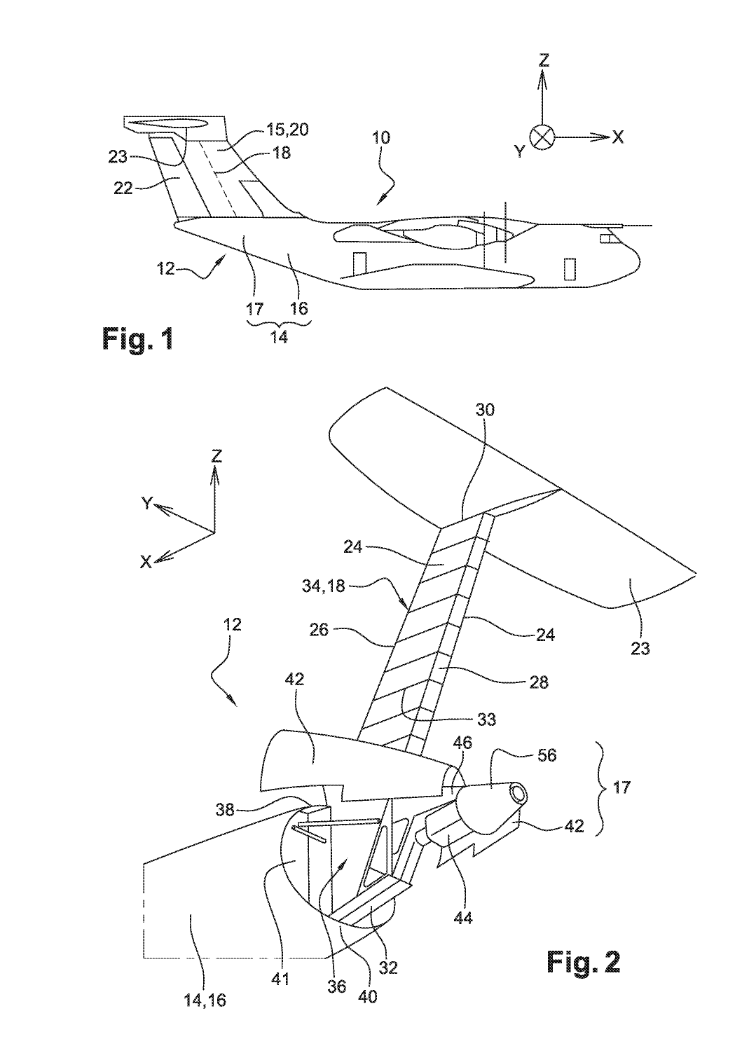

FIG. 1 illustrates an aircraft 10 comprising an aircraft rear section 12 according to a preferred embodiment of the invention.

In the description that follows, the longitudinal direction of the aircraft is referred to as X, the vertical direction (thus defined when the aircraft is stationed on a horizontal surface) is defined as Z, and the transverse direction, orthogonal to the previous two directions, is defined as Y.

The aircraft rear section 12 notably comprises a fuselage 14 and a vertical stabilizer 15. In the terminology adopted in the present description, the fuselage 14 is divided into a fuselage section 16 on the front side of the aircraft and a tail section 17 on the rear side of the aircraft.

In the example illustrated, the fuselage is formed of a skin, of circumferential frames, and of longitudinal stiffeners or stringers. These elements, which may be of a conventional type, are not visible in detail in the figures.

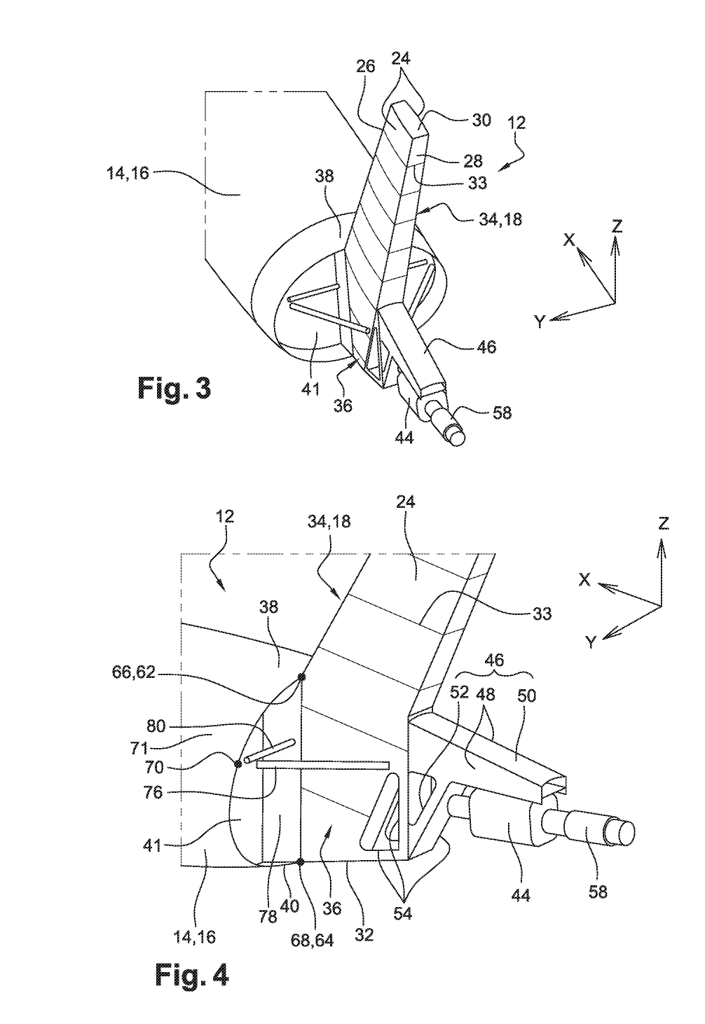

The vertical stabilizer 15 comprises a box-section structure 18 (FIG. 2), and an aerodynamic fairing 20 and a rudder 22 (FIG. 1) which are mounted on the box-section structure 18. For the sake of clarity, the aerodynamic fairing 20 and the rudder 22 are not visible in FIGS. 2 to 10a.

In the example illustrated, the vertical stabilizer 15 bears a horizontal stabilizer 23, visible only in FIG. 1, provided with an elevator. The assembly formed by the vertical stabilizer 15 and the horizontal stabilizer 23 thus constitutes a T-shaped empennage.

In a way known per se, the box-section structure 18 of the vertical stabilizer 15 is formed of two opposite lateral walls 24 (FIG. 2), of a front spar 26, of a rear spar 28, of an upper spar 30 and of a lower spar 32, and of internal stiffening ribs 33. It should be noted that each of these elements may be produced as a single piece or as several parts assembled with one another.

According to one particular feature of the present invention, as illustrated by FIGS. 2 to 4, the box-section structure 18 of the vertical stabilizer 15 comprises a box-section upper part 34 extending on the outside of the tail section 17 and a box-section lower part 36 housed inside the tail section 17. That should be interpreted as meaning that the box-section structure 18 comprises spars and internal stiffening ribs both on the outside and on the inside of the tail section 17. The box-section structure 18 may further comprise lateral panels likewise on the outside and on the inside of the tail section 17.

The box-section lower part 36 of the box-section structure 18 of the vertical stabilizer 15 is connected to the fuselage section 16 in a way that is described in detail later on in the present description.

In addition, the tail section 17 is wholly supported by the box-section structure 18, as will become clearer in what follows.

The aircraft rear section 12 further comprises a fuselage sealed end 41 which is designed to form, in a way known per se, the rearmost limit of a pressurized region of the aircraft, and which is situated forward of the box-section structure 18 so that the box-section lower part 36 of this structure 18 is housed in an unpressurized part of the fuselage 14.

In the example illustrated, as can be seen in FIG. 2, the aircraft rear section 12 comprises two external cowls 42 pivot-mounted on the box-section structure 18 of the vertical stabilizer 15, one on each side thereof. Each of these external cowls 42 can be moved between an open position (visible in FIG. 2) allowing access to the inside of the fuselage, and a closed position in which the external cowls 42 form part of the aerodynamic profile of the fuselage. To this end, the box-section structure 18 comprises, for example, fittings arranged level with the upper end of the box-section lower part 36 of the box-section structure 18 and to which the external cowls 42 are articulated, as will become clearer in what follows.

In the embodiment illustrated, the aircraft rear section 12 also comprises an auxiliary power unit 44 or APU borne by the box-section structure 18 and housed within the tail section 17 (FIG. 4).

More specifically, the box-section structure 18 of the vertical stabilizer 15 comprises an extension taking the form of a box section and extending rearward to form a support pylon 46 to which the auxiliary power unit 44 is attached. The support pylon 46 is thus formed of two lateral walls 48 respectively comprising extensions of the lateral walls 24 of the box-section structure 18, and of an upper wall 50 and a lower wall 52 respectively comprising extensions of two internal ribs of the box-section structure 18 (FIG. 4).

As an alternative, the pylon for the auxiliary power unit 44 may comprise a structure attached to the box-section structure 18, for example using fish plates.

In the example illustrated, the support pylon 46 further comprises supporting beams 54 which bear on the box-section structure 18, under the support pylon 46.

The aircraft tail section 17 comprises a fuselage tail end part 56 (FIG. 2), of conical overall shape, arranged around an exhaust duct 58 of the auxiliary power unit 44 (FIG. 4) and fixed to the support pylon 46. The fuselage tail end part 56 is thus borne indirectly by the box-section structure 18 of the vertical stabilizer 15.

As an alternative, it is possible for the aircraft tail section 17 to have no pivoting external cowls and to be formed wholly of a fixed skin, possibly stiffened by frames and/or stringers, without departing from the scope of the invention.

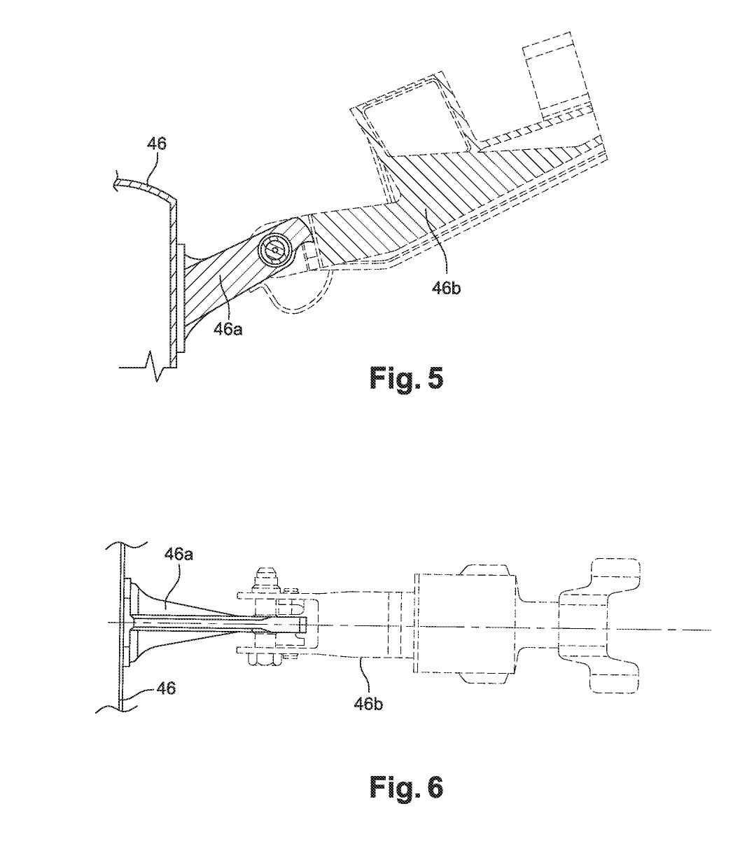

FIGS. 5 and 6 illustrate the means that allow the external cowls 42 to be articulated to the box-section structure 18 and to the extension forming a support pylon 46. FIGS. 5 and 6 thus show part of this support pylon 46, to which is attached a first fitting 46a comprising one end which is articulated to a second fitting 46b and to which one of the external cowls 42 (not visible in FIGS. 5 and 6) is fixed. Attachment of this external cowl 46 to the box-section structure 18 is performed in a similar way, as is attachment of the other external cowl 42 to the box-section structure 18 and to the extension forming a support pylon 46.

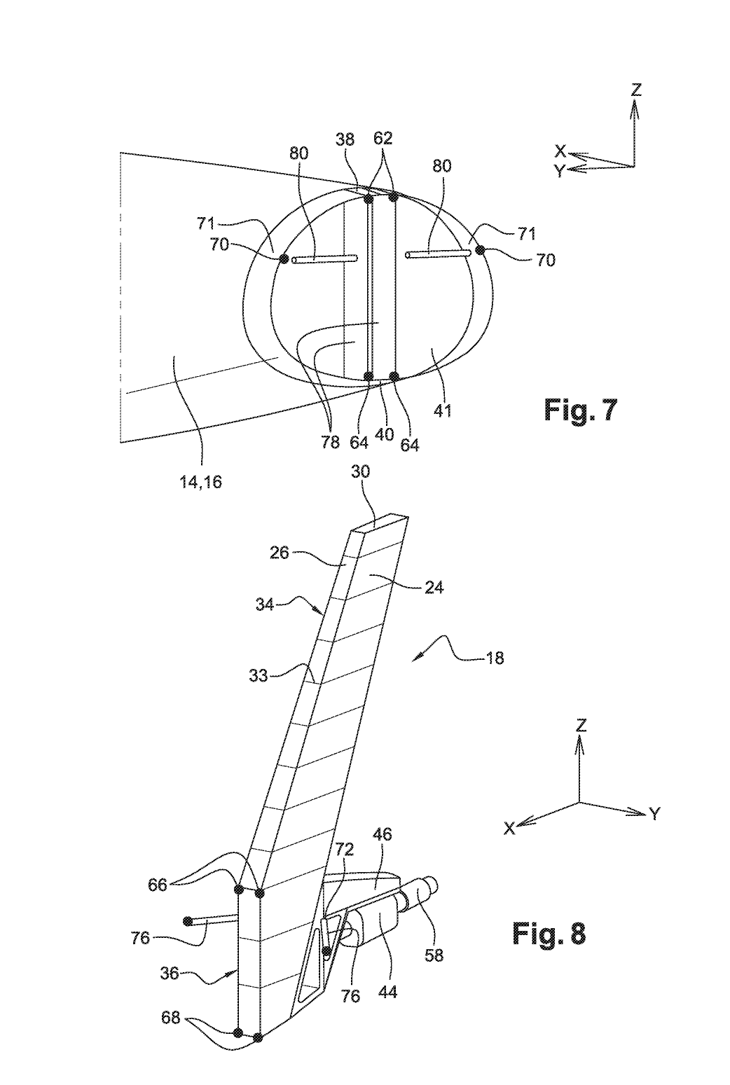

FIGS. 7 and 8 show the connecting means that provide connection between the box-section structure 18 and the fuselage section 16.

In general, these connecting means connect anchor points on the fuselage to anchor points on the box-section structure 18.

More specifically, the fuselage section 16 comprises, for example, two first anchor points 62 arranged in an upper part 38 of the fuselage section 16 and two second anchor points 64 arranged in a lower part 40 of the fuselage section 16 (FIG. 7). The box-section lower part 36 of the box-section structure 18 comprises, for example, two third anchor points 66 situated level with its upper end, and two fourth anchor points 68 situated level with its lower end (FIG. 8).

The fuselage section 16 further comprises two fifth anchor points arranged on two opposite lateral portions 71 of the fuselage (FIG. 7), and the box-section lower part 36 of the box-section structure 18 comprises two sixth anchor points 72, respectively arranged on two opposite sides of a rear portion of the box-section lower part 36 (only one of these sixth anchor points 72 is visible in FIG. 8).

The connecting means comprise, for example, tension bolts, preferably four of these, respectively connecting the first and second anchor points 62, 64 to the third and fourth anchor points 66, 68, so that the tension bolts notably contribute to the transmission of longitudinal load between the box-section structure 18 and the fuselage section 16, as will become more clearly apparent in what follows.

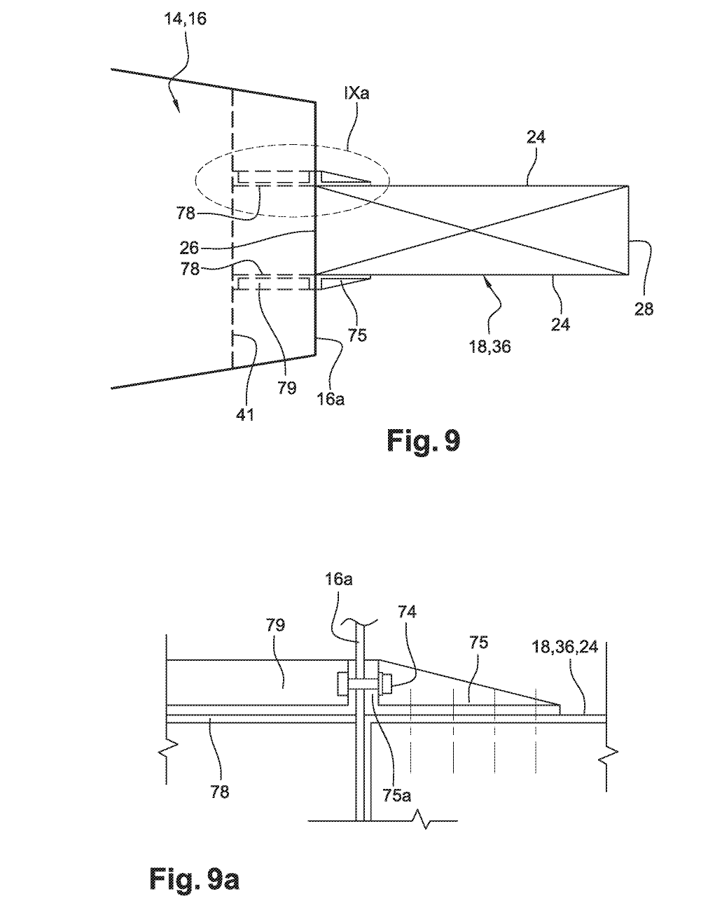

FIGS. 9 and 9a illustrate in greater detail how the box-section structure 18 is attached to the fuselage section 16. FIG. 9 shows the fuselage section 16 and, in particular, shows a circumferential frame 16a belonging to the fuselage section 16, and third fittings 75 fixed respectively to the two opposite lateral walls 24 of the box-section structure 18. The third fittings 75 each comprise a fixing head 75a fixed to the circumferential frame 16a by means of one of the aforementioned tension bolts, bearing the reference 74 in FIG. 9a.

The connecting means further comprise two link rods 76 (FIGS. 4 and 8) respectively connecting the fifth anchor points 70 to the sixth anchor points 72 so that the two lateral link rods contribute to the lateral stabilization of the box-section structure 18 with respect to the fuselage section 16.

The connecting means 74, 76 thus allow transmission of all of the load between the box-section structure 18 and the fuselage section 16.

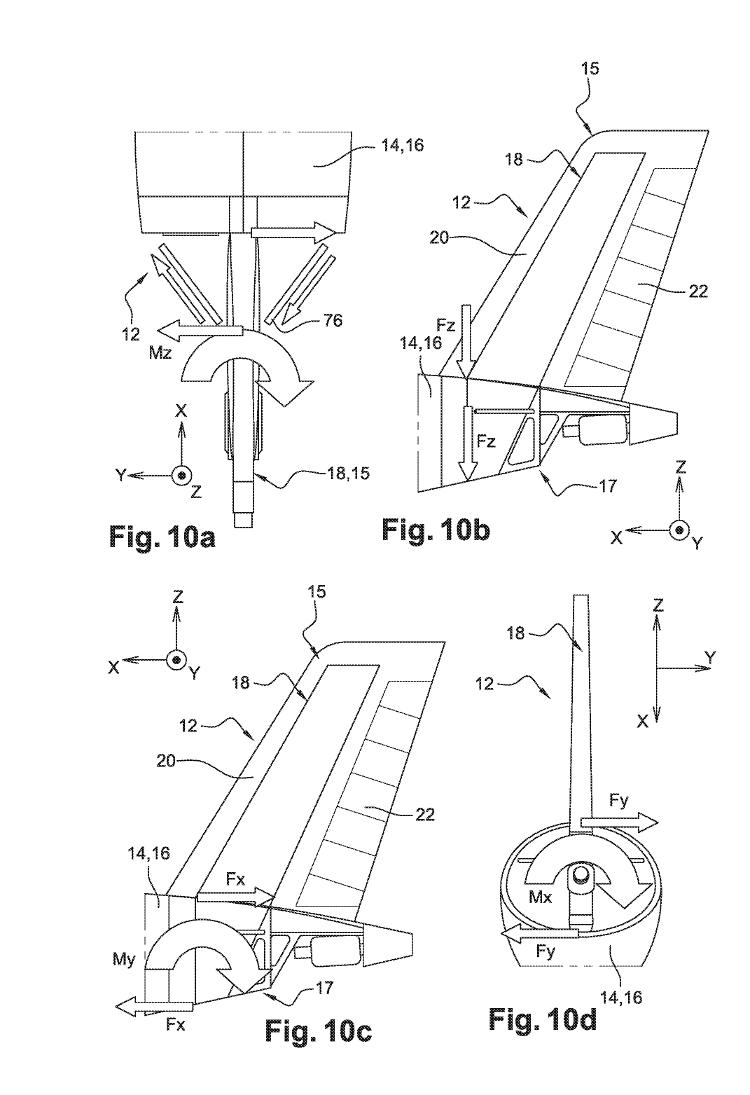

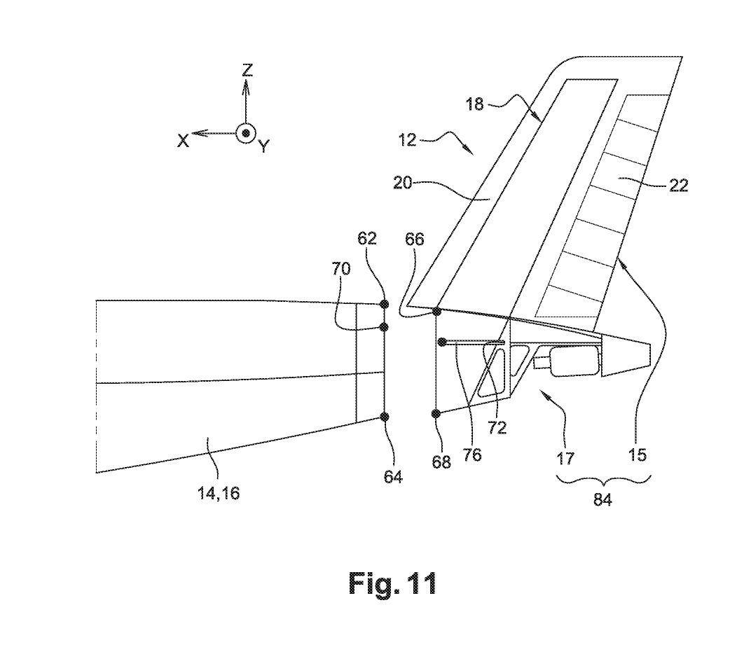

In particular, the lateral link rods 76 make it possible to react the turning moment Mz in the vertical direction Z (FIG. 10a). The tension bolts 74 are designed to work in tension and in shear such that these tension bolts 74 are able to react vertical load Fz (FIG. 10b), to react longitudinal load Fx and to react the turning moment My in the transverse direction Y (FIG. 10c), and to react transverse load Fy and the turning moment Mx in the longitudinal direction X (FIG. 10d).

Moreover, the fuselage sealed end 41 may be fixed directly to the front spar 26 of the box-section structure 18.

As an alternative, as FIGS. 4 and 7 show, the fuselage section 16 may be reinforced by one or more vertical beams 78, for example two of these, which are interposed between the fuselage sealed end 41 and the box-section structure 18 so as to connect the upper part 38 of the fuselage section 16 to the lower part 40 of the fuselage section 16.

In this case, the fuselage section 16 is advantageously reinforced by two transverse link rods 80 respectively connecting the vertical beams 78 to the two lateral portions 71 of the fuselage section 16.

In the example illustrated, the first fittings 75 are arranged in the extension of second fittings 79 which respectively connect the circumferential frame 16a to the vertical beams 78 and to the fuselage sealed end 41.

In general, the invention thus proposes to make the box-section lower part 36 of the box-section structure 18 of the vertical stabilizer 15 adopt the role of primary structure for the tail section 17 of the aircraft 10. It is thus the box-section structure that wholly bears the tail section 17.

Unlike in aircraft of known type, in which the tail section comprises a heavy primary structure independent of the vertical stabilizer and in which the skin and the frames of the fuselage contribute to transmitting load, the fuselage elements of the tail section 17, such as the external cowls 42 and the fuselage tail end part 56 play no structural part in the aircraft 10 according to the invention. These fuselage elements are simply borne by the box-section lower part 36 of the box-section structure 18, which connect them to the fuselage section 16.

The invention thus makes it possible to reduce the bulk and mass of the tail section 17.

The invention in particular makes it possible to avoid the need to resort to a heavy and costly interface for joining together the box-section structure 18 of the vertical stabilizer and a tail section primary structure, which is what has to be done in aircraft of known type.

The invention also makes it possible to simply assemble the aircraft rear section 12.

Specifically, this assembly can be performed by means of a method comprising the following steps:
on the one hand, a step comprising preassembling the fuselage section 16 and, on the other hand, a step comprising preassembling an aircraft tail assembly 84, the aircraft tail assembly comprising the vertical stabilizer 15 and the tail section 17, then
a step comprising assembling the fuselage section 16 with the aircraft tail assembly 84 by fixing the box-section lower part 36 of the box-section structure to the fuselage section 16, for example by connecting the or each first anchor point 62 to a corresponding third anchor point 66 and by connecting the or each second anchor point 64 to a corresponding fourth anchor point 68.

In the example illustrated, the step involving preassembling the aircraft tail assembly comprises a sub-step involving articulating the link rods 76 to the sixth anchor points 72 on the box-section structure 18, and the step comprising assembling the fuselage section 16 with the aircraft tail assembly 84 comprises a sub-step involving articulating the link rods 76 to the fifth anchor points 70 on the fuselage section 16.

In the example illustrated, the step comprising preassembling the aircraft tail assembly comprises a sub-step involving mounting the external cowls 42 such that they can rotate on the box-section structure 18, and a sub-step involving attaching the auxiliary power unit 44 to the box-section structure 18.

FIG. 11 illustrates the bringing-together of the fuselage section 16 and of the aircraft tail assembly 84 (the latter being depicted without the external cowls 42), this bringing-together being performed before these elements are assembled with one another.

One advantage of this method is that it allows the aircraft tail assembly 84 to be preassembled, notably with all of the ancillaries intended for the control surfaces of the rear empennage and for the auxiliary power unit, prior to final assembly of the aircraft.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An aircraft rear section, comprising:
a fuselage, and
a vertical stabilizer,
the fuselage being divided into a fuselage section situated on a front side of the aircraft rear section and a tail section situated on a rear side of the aircraft rear section, and
the vertical stabilizer comprising a box-section structure,
the box-section structure comprising a box-section upper part extending on the outside of the tail section, and a box-section lower part housed inside the tail section, and
the tail section being wholly supported by said box-section structure.

2. The aircraft rear section as claimed in claim 1, wherein the tail section comprises at least one external cowl pivot-mounted on the box-section structure.

3. The aircraft rear section as claimed in claim 1, further comprising an auxiliary power unit borne by the box-section structure.

4. The aircraft rear section as claimed in claim 1, wherein
the fuselage section comprises at least one first anchor point arranged in an upper part of the fuselage section and at least one second anchor point arranged in a lower part of the fuselage section; and
the box-section lower part of the box-section structure comprises at least one third anchor point connected to the at least one first anchor point of the fuselage section, and at least one fourth anchor point connected to the at least one second anchor point of the fuselage section.

5. The aircraft rear section as claimed in claim 4, wherein the at least one first anchor point is connected to the at least one third anchor point by means of a tension bolt configured to transmit longitudinal load between the box-section structure and the fuselage section, and the at least one second anchor point is connected to the at least one fourth anchor point by means of a tension bolt configured to transmit longitudinal load between the box-section structure and the fuselage section.

6. The aircraft rear section as claimed in claim 4, further comprising two lateral link rods respectively connecting two fifth anchor points, arranged on two opposite lateral portions of the fuselage section respectively, to two sixth anchor points, arranged respectively on two opposite sides of a rear portion of the box-section lower part of the box-section structure, so that the two lateral link rods contribute to laterally stabilizing the box-section structure with respect to the fuselage section.

7. The aircraft rear section as claimed in claim 1, further comprising a fuselage sealed end mounted in the fuselage section and arranged forward of the box-section structure and some distance therefrom.

8. The aircraft rear section as claimed in claim 1, further comprising a horizontal stabilizer wholly supported by said box-section structure.

9. An aircraft, comprising an aircraft rear section, comprising:
a fuselage, and
a vertical stabilizer,
the fuselage being divided into a fuselage section situated on a front side of the aircraft rear section and a tail section situated on a rear side of the aircraft rear section, and
the vertical stabilizer comprising a box-section structure,
the box-section structure comprising a box-section upper part extending on the outside of the tail section, and a box-section lower part housed inside the tail section, and
the tail section being wholly supported by said box-section structure.

10. A method for assembling an aircraft rear section, and which comprises the following steps:
preassembling a fuselage section and,
preassembling an aircraft tail assembly, the aircraft tail assembly comprising a vertical stabilizer comprising a box-section structure, and a tail section attached to the box-section structure such that a box-section lower part of the box-section structure is housed inside the tail section, while a box-section upper part of the box-section structure extends on the outside of the tail section, then
assembling the fuselage section with the aircraft tail assembly by fixing the box-section lower part of the box-section structure to the fuselage section so as to obtain an aircraft rear section, comprising:
a fuselage, and
the vertical stabilizer,
the fuselage being divided into the fuselage section situated on a front side of the aircraft rear section and the tail section situated on a rear side of the aircraft rear section, and, the tail section being wholly supported by said box-section structure.

11. The method as claimed in claim 10, in which the fuselage section comprises at least one first anchor point arranged in an upper part of the fuselage section and at least one second anchor point arranged in a lower part of the fuselage section, and the box-section lower part of the box-section structure comprises at least one third anchor point and at least one fourth anchor point, and in which the step comprising assembling the fuselage section with the aircraft tail assembly comprises a sub-step involving connecting the at least one first anchor point to the at least one third anchor point and in connecting the at least one second anchor point to the at least one fourth anchor point.

12. The method as claimed in claim 10, wherein the step comprising preassembling the aircraft tail assembly comprises a sub-step involving pivotally mounting at least one external cowl on the box-section structure.

13. The method as claimed in claim 10, wherein the step comprising preassembling the aircraft tail assembly comprises a sub-step involving fixing an auxiliary power unit to the box-section structure.

14. The method as claimed in claim 10, wherein the step comprising preassembling the aircraft tail assembly comprises a sub-step involving fixing a horizontal stabilizer to the box-section structure.
